(19) United States
(12) Patent Application Publication
(10) Pub. No.: US 2021/0142284 A1
(43) Pub. Date: May 13, 2021

(54) METHOD AND SYSTEM FOR ANONYMOUS ECOMMERCE SHIPMENT

(71) Applicant: SHOP PRIVATE LLC, Glenview, IL (US)

(72) Inventors: Andrew KACZMAREK, Boulder, CO (US); David Rozenblat, Riverwoods, IL (US)

(21) Appl. No.: 17/004,298

(22) Filed: Aug. 27, 2020

Related U.S. Application Data
(63) Continuation-in-part of application No. 16/859,877, filed on Apr. 27, 2020.
Application No. 16/859,877 is a continuation-in-part of application No. 16/677,571, filed on Nov. 7, 2019.

(51) Int. Cl. G06Q 10/08; G06Q 20/38; G06Q 20/02; G06Q 20/08; G06Q 40/02; G06Q 30/00; G06F 21/62; G06F 16/9535

(52) U.S. Cl. CPC G06Q 10/08355; G06Q 20/383; G06Q 20/02; G06Q 20/0855; G06Q 10/0836; G06Q 2220/00; G06Q 30/018; G06Q 20/3829; G06F 21/6254; G06F 16/9535; G06Q 40/02

(57) ABSTRACT

A method for enabling anonymous shipment of a package containing goods purchased by a customer from a vendor for delivery to a customer and an address unknown to the vendor is provided. The method includes, storing personal information associated with the customer in a shipping intermediary's secure database including the actual name and associated intended delivery address, and generating a tokenized customer name representing the actual name along with a preferred intermediary address associated with the shipping intermediary. The tokenized customer name and the preferred intermediary address do not include the actual name and any of the intended delivery address information for the package. The method further includes providing to the vender the tokenized customer name and the preferred intermediary address in place of the actual name and the intended delivery address.

### RELATED APPLICATIONS

The present application is a continuation-in-part of co-pending U.S. patent application Ser. No. 16/859,877, filed Apr. 27, 2020, which is a continuation-in-part of co-pending U.S. patent application Ser. No. 16/677,571, filed Nov. 7, 2019, both of which are incorporated by reference herein in their entirety.

### BACKGROUND OF THE INVENTION

The advent of electronic commerce over the Internet has spurred economic development by fostering new products and industries and revitalizing old ones. Electronic commerce has also brought an unprecedented array of choices to consumers, who now can make purchases without regard to geographical or political boundaries. However, the increasingly global interconnectivity making such electronic commerce possible is fraught with potential dangers to the consumer. One such danger is the misuse of personal and financial information. Indeed, each time that a consumer makes an online purchase from a vendor over the World Wide Web (hereafter “Internet” or “Web”), he or she typically must supply the vendor with personal information, such as his or her name, address, telephone numbers, email address and financial information such as a credit card number, for example. Often the consumer is also invited to supply other information, such as annual income, number of dependents, etc. Such information tends to be persistent, and is usually stored in databases (whether such database belong to the vendor, credit agencies or other vendors) and may be used for purposes wholly unforeseen by the customer at the time of the original transaction. Individual consumers are not the only ones that may be harmed by such practices; businesses also have an interest in protecting their business information, be it customer lists, key suppliers and the like.

Even if the online purchase, however, is somehow made in an anonymous or quasi-anonymous fashion (that is, without divulging personal or financial information to the vendor), the vendor typically must still ship the package to a delivery address, which may be the purchaser's home or business address or the address of a customer, friend or relative. This information, then, must be given to the vendor who then may store the supplied information for later use or misuse.

Some of the potential consequences of providing such addressee information to the vendor are discussed with reference to FIG. 1, which shows a conventional method of shipping goods from a vendor to a customer. As shown therein, the customer makes an electronic purchase at S11, and is invited to provide the vendor with his or her personal and financial information, such as payment information (credit card numbers, for example) and personal information such as telephone numbers, physical and/or electronic addresses (email address, for example) and shipping information, as shown at S13. At step S14, the vendor processes and stores the supplied information (typically in a database, as shown at reference numeral 10 in FIG. 1). The vendor then packages the goods purchased by the customer, applies a shipping label to the package and surrenders the package to a shipper or freight forwarder (such as the US post office, UPS® or FedEx®, for example) for delivery to the customer 12.

However, the effects of supplying the vendor with the above-listed personal and financial information are not confined to the underlying purchase. Indeed, as shown in FIG. 1, the vendor may itself send the customer 12 unwanted email, subject the customer 12 to unwanted telephone solicitations, or send the customer unsolicited commercial mailings (commonly referred to as “junk mail”). More egregious still, the vendor may sell the customer-provided information to third parties, collectively referenced in FIG. 1 at 14. The vendor may also sell aggregate customer information—that is, information that does not identify any particular one customer, a relatively benign act. However, the vendor may also sell his or her customers' individual personal and financial information to third parties 14, without the consent or knowledge of the affected customers. In turn, such third parties 14 may also subject the customer 12 to a barrage of unwanted emails, solicitations and/or junk mail. The customer, if a business, may have business reasons such as the preservation of trade secrets, for wanting anonymous shipping. Such unwelcome intrusions are, however, but a few manifestations of the universe of all possible deliberate uses and misuses of personal and financial information. Indeed, the customers' personal and financial information may be purchased or intercepted by parties wholly unforeseen by the customer and used for illegal purposes, such as to facilitate identity theft, for example. This problem is exacerbated by the increasing proliferation of e-commerce vendors and Web sites, each of which collects and uses the customer's personal and financial information.

However, even if the actual purchase is somehow made in an anonymous or quasi-anonymous fashion (akin to a face-to-face cash transaction, for example), the package containing the purchased goods still must be delivered to the customer or other addressee. In turn, this entails that the name and address of the recipient of the package be provided to the vendor, with all of the above-detailed potential consequences of providing such information.

### SUMMARY

The present invention is defined by the following claims, and nothing in this section should be taken as a limitation on those claims.

In one aspect, a method for enabling anonymous shipment of a package containing goods purchased by a customer from a vendor for delivery to a customer and an address unknown to the vendor is provided. The method includes, but is not limited to, storing personal information associated with the customer in a third party entity's secure database including the actual name and intended delivery address associated with an account maintained by the customer at the shipping intermediary, and generating a tokenized customer name representing the actual name along with a preferred intermediary address associated with the shipping intermediary using one or more computer systems operated by the shipping intermediary. The tokenized customer name and the preferred intermediary address do not include the actual name and any of the intended delivery address information for the package. The method further includes, but is not limited to, sending the tokenized customer name and the preferred intermediary address from at least one of the one or more computer systems operated by the shipping intermediary directly to the customer, and providing to the vender the tokenized customer name and the preferred intermediary address in place of the actual name and the intended delivery address.

In one aspect, a method for enabling anonymous purchasing and shipment of goods from a vendor for delivery to a customer and an address unknown to the vendor is provided. The method includes, but is not limited to, storing personal and financial information associated with the customer in a third party entity's secure database including the actual name and intended delivery address associated with an account maintained by the customer at the shipping intermediary, and generating a tokenized customer name representing the actual name along with a preferred intermediary address associated with the shipping intermediary using one or more computer systems operated by the shipping intermediary. The tokenized customer name and the preferred intermediary address do not include the actual name and any of the intended delivery address information for the package. The method further includes, but is not limited to, generating an anonymous financial instrument to allow the customer to provide the vender with an anonymous payment through a bank, sending the tokenized customer name and the preferred intermediary address from at least one of the one or more computer systems operated by the shipping intermediary directly to the customer, sending the anonymous financial instrument to the customer, and providing to the vender the tokenized customer name and the preferred intermediary address in place of the actual name and the intended delivery address. The method further includes, but is not limited to, providing to the vender the anonymous financial instrument to conduct anonymous payment for the customer through a bank.

In one aspect, a method for enabling anonymous shipment of a package containing goods purchased by a customer from a vendor for delivery to a customer and an address unknown to the vendor is provided. The method includes, but is not limited to, storing personal information associated with the customer in a third party entity's secure database including the actual name and intended delivery address associated with an account maintained by the customer at the shipping intermediary, and generating a tokenized customer name representing the actual name and the intended delivery address using one or more computer systems operated by the shipping intermediary. The tokenized customer name does not include the actual name and any of the intended delivery address information for the package. The method further includes, but is not limited to, providing to the vender the tokenized customer name in place of the actual name and the intended delivery address and placing the tokenized customer on the package containing goods purchased by the customer, providing a local shipper with a pickup address of the package along with the tokenized customer name, and providing the local shipper with the intended delivery address associated with the tokenized customer name and using the local shipper to deliver the package to the intended delivery address.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a flowchart of a conventional method of shipping goods from a vendor to a customer, in accordance with one embodiment of the present invention.

FIG. 2 depicts a block schematic diagram of an exemplary computing system, in accordance with some embodiments of the present invention.

FIG. 3 depicts a flowchart of a method for anonymous shipping and payment, in accordance with one embodiment of the present invention.

FIG. 4 depicts a flowchart of a method for anonymous shipping of goods using a local shipper, in accordance with one embodiment of the present invention.

FIG. 5 depicts a flowchart of a method for anonymous shipping and payment, in accordance with one embodiment of the present invention.

FIG. 6 depicts a perspective view of a smart electronic automated locker, in accordance with one embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In the description that follows, the following terms will be defined as follows:

VENDOR: Any person or entity that sells and/or offers goods and/or services for Sale (the seller).

CUSTOMER: Any person or entity that purchases goods and/or services from a Vendor (the buyer). The customer may be a business who, for business, privacy, or business reasons (such as the preservation of trade secrets, for example) may want to purchase and receive goods anonymously.

DELIVERY ADDRESS: A location to which the package is to be delivered. The delivery address may be a physical location to which a physical package may be delivered or may be an electronic address over a computer network such as the Internet.

SHIPPER: Any person or entity that ships or forwards the purchased goods and/or services to the delivery address.

PACKAGE: Any package that contains the goods or item(s) purchased by purchaser that is to be delivered by the shipper to the delivery address. The package may be in any form, such as a letter or package. The package may also be large, such as a Sea-Land® container or a railroad boxcar, for example. Alternatively, the package may be in electronic form and may include one or more electronic files to be delivered to an electronic address.

SHIPPING INTERMEDIARY: Any person or entity which receives the package from the vender and then prepares that package for shipment to the customer's intended delivery address or stores, retrieves and presents the package directly to the customer, to an agent of the customer, or to a local shipper for delivery of the package directly to the intended delivery address for the package.

BANK: As used herein, the term “bank” includes all financial services institutions accepting deposits of cash, negotiable securities, marketable shares/stock into numbered (or otherwise uniquely-identified) accounts and honoring checks, drafts and/or other customer instructions. Such a definition includes (but is not limited to) traditional banks and savings institutions; stockbrokers, online trading concerns, credit unions and any institution that legally identifies with and has some financial and fiduciary relationship with an account holder and that has the ability to honor customer or account holder instructions referring to specific accounts. Within the context of the present invention, the term “bank” also includes such institutions as post offices or other governmental agencies that carry out banking or quasi-banking functions.

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those skilled in the art will appreciate that some of the acts and operations described hereinafter can also be implemented in hardware, software, and/or firmware and/or some combination thereof.

Prior to proceeding to the more detailed description of the present invention it should be noted that, for the sake of clarity and understanding, identical components which have identical functions have been identified with identical reference numerals throughout the several views illustrated in the drawing figures.

With reference to FIG. 2, depicted is an exemplary computing system 100 for implementing embodiments. In one embodiment, the computing system 100, or portions of it, may be found within circuitry 60, described herein, however, in another embodiment the circuitry 60 does not have all or any aspects of the computing system 100, but is rather a simplified electrical circuit with no intelligence or software control. FIG. 2 includes a computer 110, which could be any one of a remote computer or device or local computer or device. Computer 110 may be a portable device, wherein at least some or all of its components are formed together in a single device which can be carried around by a person. The computer 110 includes a processor 111, memory 120 and one or more drives 130. The drives 130 and their associated computer storage media provide storage of computer readable instructions, data structures, program modules and other data for the computer 110. Drives 130 can include an operating system 140, application programs 150, program modules 160, and program data 180. Computer 110 further includes input devices 190 through which data or signals may enter the computer 110, either automatically or by a user who enters commands and data. Input devices 190 can include: an electronic digitizer; a microphone; an optical camera; a keyboard; a mechanical switch; a sensor such as a pressure sensor, and weight sensor, an optical sensor, an electro-optical sensor, and a vibration sensor; an electro-mechanical switch; an electrical switch; and a pointing device, commonly referred to as a mouse, trackball or touch pad. Other input devices 190 may include a joystick, game pad, satellite dish, scanner, and the like. In one or more embodiments, input devices 190 are portable devices that can direct display or instantiation of applications running on processor 111.

These and other input devices 190 can be connected to processor 111 through a user input interface that is coupled to a system bus 192, but may be connected by other interface and bus structures, such as a parallel port, game port or a universal serial bus (USB). Computers such as computer 110 may also include other peripheral output devices such as speakers and/or display devices, which may be connected through an output peripheral interface 194 and the like.

Preferably, computer 110 includes a radio 198 for wirelessly transmitting and receiving data for the computer 110 with the aid of an antenna. Radio 198 may wirelessly transmit and receive data using WiMAX′, 802.11a/b/g/n, Bluetooth™, 2G, 2.5G, 3G, and 4G, wireless standards.

Computer 110 may operate in a networking environment 199 using logical connections to one or more remote computers, such as a remote computer 185. The remote computer 185 may be a smartphone, a personal computer, a server, a router, a network PC, a peer device or other common network node, and may include many if not all of the elements described above relative to computer 110. Networking environments 199 are commonplace in offices, enterprise-wide computer networks, intranets and the Internet. For example, in the subject matter of the present application, computer 110 may comprise a source machine from which data is being migrated, and the remote computer 185 may comprise a destination machine. Note, however, that source and destination machines need not be connected by networking environment 199 or any other means, but instead, data may be migrated via any media capable of being written by the source platform and read by the destination platform or platforms. When used in a LAN or WLAN networking environment 199, computer 110 is connected to the LAN through a network interface 196 or an adapter. When used in a WAN networking environment 199, computer 110 may include a modem or other means for establishing communications over the WAN to environments such as the Internet. It will be appreciated that other means of establishing a communications link between computers 110 and other computers, such as remote computer 185, may be used. According to one embodiment, computer 110 is connected in a networking environment 199 such that processor 111 can process incoming and outgoing data.

FIG. 3 is a flowchart of the present method 300 for anonymous shipping, according to an embodiment of the present invention. The method 300 begins at step 301. At step 302, the customer provides at least personal information, such as the customer's name and address, and preferably, financial information, such as the customer's bank account or financial instrument (i.e. credit card, social security, etc.) information to a third party entity for safekeeping the information in a database, such as a secure database 210, which is separate and apart from the vender's database, and for assisting the customer in completing a purchase from a vender without having to provide the vender with the customer's personal information and actual financial information. By using a third party entity, the customer is able to keep the customer's address or an intended delivery address and/or the actual name of the package recipient, such as the customer's name, from the vendor. The third party entity may be any type of entity which can retain confidential information and which is not the vender, such as a bank 20 or a shipping intermediary, however, the third party entity does not necessary have to be the bank 20 or the shipping intermediary, and may be a separate entity altogether that may instead communicate information with the bank 20 or the shipping intermediary to assist in the anonymous purchase of goods/services from the vender without having to provide the vender with the customer's personal information and actual financial information.

Preferably, the secure database 210 is kept in a remote location on a centralized server that is fully accessible only by the third party entity and which has limited access or indirect access by other entities, such as the shipping intermediary and the bank. In one embodiment, the secure database 210 encrypts the information stored so that on the third party entity may have direct and full access to the database. In one embodiment, information stored in the secure database is erased after a set amount of time or after a condition is met. The centralized server not only maintains the secure database but is also capable of generating the tokenized customer name, either by confirming the uniqueness of a name generated by the customer or generating its own name. Preferably, the centralized server is coupled to a client device of the shipping intermediary, such as a smart electronic automated locker 600, a smartphone, or a local computer or tablet. The shipping intermediary uses the client device to communicate with the centralized server and share information between the shipping intermediary and the third party entity, such as the tokenized customer name, the secondary token, and other such information. Additionally, the centralized server is also coupled of a client device of the customer, such as a smartphone, a local computer, or tablet, in order to communicate information such as the tokenized customer name, the secondary token, and the preferred intermediary address to the customer.

Preferably, the centralized server includes a communication device, such as a modem, a networking card, or a wireless communication device (WiFi or Bluetooth® transceiver) or other means for establishing communications over a WAN to environments such as the Internet or a network 602. The communications device may send and receive the tokenized customer name, the preferred intermediary address, the secondary token, and other such information between the centralized server and the client devices of the customer and the shipping intermediary via a network, such as the Internet.

The intended delivery address may be the customer's address, a recipient's address, or any address that the customer wishes to maintain privacy and anonymity for and does not wish the vender to know when purchasing products and/or services from the vendor. Additionally, the actual name of the package recipient may refer to the customer's name, the recipient's name, or any name that the customer wishes to maintain privacy and anonymity for and does not wish the vender to know when purchasing products and/or services from the vendor.

Preferably, the bank 20, or financial institution, will have the customer's financial information which will be needed to provide the vender with payment for the goods/services purchased by the customer. The bank 20 is well suited to intermediate in electronic transactions, as it already stores the customer's financial and personal information in its secure database(s) 210. According to the present invention, the bank 20 preferably restricts access to the customer's personal and financial information, such as account numbers, credit card numbers, passwords, address, phone numbers and the like.

The shipping intermediary provides a mechanism for shipping the item or service purchased by the customer to the intended delivery address without disclosing the intended delivery address to the vender. The shipping intermediary is used to shield the actual name and intended delivery address from the vender so that the customer or the recipient of the package may maintain an additional level of anonymity when purchasing goods and/or services from the vendor. The third party entity may maintain a secure database which may be separate from the bank's database and the shipping intermediary's database and which would include an actual name and intended delivery address associated with an account maintained by the customer at the third party entity.

Moving to step 304, in one embodiment, once the customer provides financial information to the third party entity, which could be the shipping intermediary and/or the bank, the third party entity, either alone or working with some other financial institution such as bank 20, generates an anonymous financial instrument to allow the customer to provide the vender with an anonymous payment through a bank. The anonymous financial instrument can be provided to the vender for payment for the goods and/or services that the customer wishes to purchase, without having to provide the vender with the customer's name. The anonymous financial instrument can be any financial instrument in which the customer's name and/or other personal information are shielded, such as: masked cards which can be used to make purchases with a fictitious name (see abine.com); prepaid debit cards which can be purchased in places such as drugstores and supermarkets; Bitcoin or other types of cryptocurrency or blockchain currency; and other services for anonymous payment such as Litecoin, Ripple, OpenCoin, MintChip, and Linden Dollars which let you pay anonymously for items and services. In one embodiment, the customer obtains on his own an anonymous financial instrument without the aid of the third party entity and uses this anonymous financial instrument to purchase goods/services from the vender.

To generate the anonymous financial instrument, the customer may provide financial information to the third party entity such as the customer's name, address, social security number, birth date, in order to generate a new financial instrument, such as a credit card or debit card. Alternatively, the customer may provide the third party entity with financial information that includes information regarding a current financial instrument owned by the customer, such as a current debit or credit card, whereby the third party entity can create a new financial instrument tied to the current financial instrument but allow for the information on the current financial instrument to remain concealed and private. In this manner, if information from the new financial instrument is compromised, it does not reveal or compromise information from the current financial instrument. For example, a new virtual credit card could be created which when used debits or charges a current credit card owned by the customer, wherein the virtual credit card would have a 16 digit credit card number which is different from that on the current credit card owned by the customer, so if compromised, the 16 digit credit card number of the virtual card could be cancelled without having to cancel the information on the current credit card, as it would not have been compromised.

In one embodiment, the third party entity generates or issues the customer a form of payment, such as a debit card, a credit card, a virtual credit card, a Bitcoin or other form of cryptocurrency or blockchain currency, or any other form of payment or anonymous financial instrument which does not contain the actual name of the customer, and which is associated with an account at a bank in the name of the customer or in the name of the shipping intermediary. For example, the third party entity may open a credit card in the name of the third party entity and only associate the credit card with the customer in the third party entity's database. In another embodiment, the third party entity may open a credit card in the name of the customer or in no name at all, and associate it with the customer, but request that the customer's name is not required to be on the card or provided when used at a vender. For example, certain debit cards do not require the customer to provide his/her name and a virtual credit card may be used to purchase goods and services online without having to provide the vender with the customer's name. In one embodiment, the tokenized customer name generated by the third party entity is provided along with the form of payment instead of the actual name. In this manner, the third party entity is able to not only provide the customer a method to enable anonymous shipment of a package from a vender, but also to provide the same customer with a method for anonymous payment for the goods/services from the vender via an anonymous payment requested through a bank.

At step 306, in order to conceal the customer's name and address when making a purchase, the third party entity generates a tokenized customer name, and preferably, also generates or determines a preferred intermediary address. Specifically, the centralized server of the third party entity may generate the tokenized customer name and determine the preferred intermediary address. In one embodiment, the customer may request and receive a tokenized customer name and preferred intermediary address from the third party entity. For each actual name and intended delivery address associated with an account maintained for the customer by the third party entity, a tokenized customer name may be generated. In one embodiment, a tokenized customer name can be generated each time a customer wishes to purchase goods/services and have a package delivered from a vender. The tokenized customer name may represent an actual name and/or intended delivery address associated with an account maintained by the third party entity for the customer.

In one embodiment, the tokenized customer name does not necessary represent an actual name and/or an intended delivery address associated with an account as the account is opened without providing the third party entity with an actual name of the customer and without providing the customer's address or intended delivery address. In one embodiment, the tokenized customer name is generated each time an account is opened for a customer or each time the customer purchases goods/services from a vender. In this embodiment, there is no need to know the customer's actual name or intended address. The customer may open an account simply by just creating a username and password with the third party entity, wherein the username and password are stored in the secure database. Upon creating a username and password, a tokenized customer name is generated by the third party entity, either by the third party entity generating it on its own or by the customer creating a random name and sending the random name to the third party entity for confirmation that the random name is unique and may be used as a tokenized customer name. Once the tokenized customer name is generated by the third party entity, a communication is sent to the customer indicating what the tokenized customer name is or indicating that the random name can be used as a tokenized customer name.

According to an embodiment of the present invention, the tokenized customer name, representing the customer's actual name and/or preferred intermediary address, are entirely devoid of any actual package delivery information, such as the customer's actual name and/or intended delivery address. Preferably, the tokenized customer name may be an entirely numerical code number or may include any other alphanumeric symbols and/or letters. As a result, the vendor is not given access to the actual name and the intended delivery address associated with the customer for the package, and thus cannot misuse the information or include such information in any later (even legitimate) marketing or sales efforts.

Preferably, the tokenized customer name is a randomly generated alphanumeric code or one that is generated using the customer's name or other information, but which does not have the customer's actual name in it. In one embodiment, the tokenized customer name is generated by or picked out by the third party entity, or created by and provided to the third party entity by the customer. The tokenized customer name may be any one of a randomly or specifically chosen alphanumeric code, a fake or fictitious name that is generated by a computer, a name or arrangement of words picked out by or generated by the third party entity, or provided by the customer, or any combination of the above. The tokenized customer name is preferably unique within the third party entity's secure database 210. That is, no two customers within the third party entity's secure database 210 may have the same tokenized customer name. Therefore, if the tokenized customer name is created by and then supplied to the third party entity by the customer, the tokenized customer name is preferably checked against all names within the secure database 210 to confirm that the tokenized customer name is unique within the secure database 210. In one embodiment, once the tokenized customer name has been generated by the third party entity, the third party entity then provides that tokenized customer name to the shipping intermediary so that the shipping intermediary can correctly identify packages which have to be reshipped upon receipt and so that the shipping intermediary can then forward the received package from the vender to the intended delivery address and provide the actual name on the package.

In one embodiment, a unique tokenized customer name is provided to the customer each time the customer purchases goods for each unique package that is shipped by the vender and received by the shipping intermediary. In this manner, the unique tokenized customer name helps the shipping intermediary match each unique package with a customer. In one embodiment, the customer can provide the unique tokenized customer name to the shipping intermediary in order to verify ownership of the customer's package which has been received by the shipping intermediary.

Preferably, the tokenized customer name may be any alphanumeric combination of letters, numbers, and symbols, which can be used to lookup an actual name and intended delivery address pair of a customer within the third party entity's secure database 210. Preferably, the tokenized customer name is provided to the customer and presented to the vender in place of the actual name, and the preferred intermediary address is provided to the customer and presented to the vender in place of the intended delivery address. If the third party entity is not the shipping intermediary, then the tokenized customer name is also provided to the shipping intermediary, preferably, along with the intended delivery address an actual name associated with that tokenized customer name. In this manner, when the shipping intermediary receives a package, the shipping intermediary can either lookup the intended delivery address an actual name associated with that tokenized customer name or the shipping intermediary can request such information from the third party entity.

In one embodiment, the tokenized customer name is generated by the computer 110, and specifically the centralized server of the third party entity. In one embodiment, the computer 110 uses a random character generator to generate a string of random characters which will be used as the tokenized customer name. The tokenized customer name may be generated by the computer 110 in many other ways as well. In one embodiment, the computer 110 uses a predetermined algorithm to generate the tokenized customer name, and in another embodiment, the customer's name is encrypted by the computer 110 into the tokenized customer name, so that the customer's name is hidden within the tokenized customer name, and can only be unlocked by the computer 110 using a specific algorithm. In one embodiment, the computer is provided with a names database of first and last names and randomly chooses a first name and then randomly chooses a last name from the names database and combines the randomly chosen first name with the randomly chosen last name to create the tokenized customer name. In one embodiment, a randomly generated alphanumeric code is added to the randomly generated first name and the randomly chosen last name. In one embodiment, the computer creates a first and last name using a randomly generated word via a combination of phonics, which is a grouping of sounds or letter combinations, in order to create a unique tokenized customer name. Upon generating the tokenized customer name, the computer 110 will then compare the newly generated tokenized customer name to each previously generated tokenized customer name in the secure database 210 to insure its uniqueness.

In one embodiment, the customer generates a nickname and provides the nickname to the intermediate third party which then uses the computer 110, or centralized server, to compare the nickname to all other tokenized customer names in order to confirm its uniqueness. If the nickname provided by the customer is found to be unique, the computer 110 or third party entity then generates a tokenized customer name that is identical to the nickname and provides a confirmation to the customer that he/she may use the nickname as a tokenized customer name and provide it to the vender when purchasing goods/services from the vender.

In addition to the tokenized customer name, for each intended delivery address associated with an account maintained by the customer, a preferred intermediary address is determined. Preferably, the shipping intermediary has multiple delivery addresses, one for each location that the shipping intermediary operates. The shipping intermediary, for example, may operate multiple locations across a region or country, whereby each location may service a specific location or region. In one embodiment, the preferred intermediary address is determined by finding the shipping intermediary addresses which allows for shipping the package in the least amount of time. In one embodiment, the preferred intermediary address is determined by finding the shipping intermediary addresses which allows for shipping the package at the lowest possible cost. Once the preferred intermediary address is determined, which may be done using a one or more computer systems operated by the shipping intermediary, then the preferred intermediary address is associated with the intended delivery address in the third party entity's secure database 210, along with the tokenized customer name and the actual name all associated with a particular customer. Furthermore, a customer may have more than actual name and intended delivery address pair, wherein each actual name and intended delivery address pair is associated with a tokenized customer name and a preferred intermediary address.

In one embodiment, the shipping intermediary includes multiple shipping intermediaries, wherein each shipping intermediary has its own unique shipping intermediary address. In one embodiment, any business, entity, person, or household can be a shipping intermediary and form a network of shipping intermediaries. Preferably, the business, entity, person, or household provides a request to become a shipping intermediary to the third party entity, which upon review of such request, approves or rejects the request from the business, entity, person, or household. If approved, the business, entity, person, or household would become a shipping intermediary and would provide an address to the third party entity for receiving packages for customer's from the vender. This would increase the footprint of the shipping intermediary by allow for many more locations to be used across a region or country to receive packages from venders and service customers. By allowing any business, entity, person, or household to become a shipping intermediary and form a network of shipping intermediaries, the number of locations which can be used to ship packages from venders for customers can increase exponentially with little cost to the third party entity and allow for a the shipping intermediaries to be closer to the venders and/or the customers. In one embodiment, the vender can be a shipping intermediary as well, preferably by providing a request to become a shipping intermediary to the third party entity. In this manner the vender can avoid having to use a shipper to ship the package and therefore avoid the cost of having to ship the package using a shipper.

The preferred intermediary address is preferably chosen by the third party entity either manually or automatically via a computer 110. The parameters for choosing the preferred intermediary address include, but are not limited to: the distance from the preferred intermediary address to the customer's intended delivery address, the distance from the vender's fulfillment center to the preferred intermediary address or the address from which the vender is sending the item or service to the customer to the preferred intermediary address, the vender's mailing zip code/city/state/region/address, the customer's mailing zip code/city/state/region/address, the delivery time from the preferred intermediary address to the vender and/or the customer, the cost of shipment from the vender to the preferred intermediary address and from the preferred intermediary address to the customer, and other such parameters.

The third party entity may retrieve the tokenized customer name and the preferred intermediary address associated with the customer from its secure database 210 and sends the tokenized customer name and the preferred intermediary address through a secure communication channel using a standardized protocol, such as the Secure Socket Layer (hereafter “SSL”), for example, to the customer, which ultimately provides this information to the vender. SSL utilizes an encryption scheme (such as a public key encryption scheme, for example) negotiated at the time of the communication and helps to ensure that electronic eavesdroppers between the third party entity and the customer cannot intercept any clear, unencrypted communication.

At step 308, once generated, preferably at least one of the tokenized customer name, the preferred intermediary address, and the anonymous financial instrument is then sent to the customer. The anonymous financial instrument may be sent to the customer, either physically or digitally, depending on the type of financial instrument, and then the customer may provide to the vender the anonymous financial instrument to conduct anonymous payment for the customer for a purchase of goods/services. Along with or separately from the anonymous financial instrument, the third party entity may also send the tokenized customer name and a preferred intermediary address, preferably through the network 199, to the customer in order to present to or provide to the vendor.

Moving to step 310, having received at least one of the tokenized customer name, the preferred intermediary address, and the anonymous financial instrument from the third party entity, the customer may express an interest to make a purchase from the vender at, for example, the vendor's physical location or ecommerce website located on the Internet. Ecommerce is a term for any type of business, or commercial transaction, that involves the transfer of information across the Internet, such as a customer's name, address, and financial information, in order to conduct a purchase or transaction. Ecommerce allows consumers to electronically exchange goods and services with no barriers of time or distance, and an ecommerce website is a website in which such a transaction may occur. Once at the vender's location or ecommerce website, the customer may then decide to make a purchase from the vendor, at which point the vendor will then prompt the customer for the customer's actual name, intended delivery address, and customer's own financial instrument.

At this point, in order to make an anonymous purchase of goods/services from the vender, the customer would provide the vender with at least one of the tokenized customer name, the preferred intermediary address, and the anonymous financial instrument in place of the customer's actual name, intended delivery address, and customer's own financial instrument, respectively.

For example, when the vender requests the actual name of the recipient of the package or the customer, the customer would provide the tokenized customer name in the name field, either when the vender requests the customer's first name or given name, and/or when the vender requests the customer's last name or surname. In some embodiment, the tokenized customer name can be divided into two or more portions, one for when the first name is requested and one for when the last name is requested. Additionally, when the vender requests the intended delivery address of the recipient of the package or the customer, the customer would provide a shipping intermediary address, and preferably, the preferred intermediary address which has been determined or assigned by the shipping intermediary to be associated with the intended delivery address. Finally, when the vendor requests the customer to provide the customer's own financial instrument, the customer can provide the anonymous financial instrument in order to shield and prevent the vendor from seeing the information on the customer's own financial instrument. In this way, the customer can complete a purchase from the vendor without having to provide the vendor any personal or financial information, such as the customer's actual name, the intended delivery address, and the customer's own financial instrument.

Therefore, in order to prevent having to provide the vender with the customer's personal information and actual financial information, the customer may provide the vender with the tokenized customer name in place of the actual name, the preferred intermediary address instead of the intended delivery address, and the anonymous financial instrument instead of the customer's current financial instrument. By providing the vender with the tokenized customer name, the preferred intermediary address, and the anonymous financial instrument, the customer is able to complete the purchase of goods/services from the vender without having to reveal to the vender the customer's personal information and actual financial information. The customer may provide the tokenized customer name, the preferred intermediary address, and the anonymous financial instrument to the vender when responding to a request from the vender for the customer's name, the customer's address, and the customer's payment information, respectively.

At step 312 upon receiving the tokenized customer name, the preferred intermediary address, and the anonymous financial instrument from the customer, the vender may requests payment from the bank using the financial instrument provided by the customer, which is preferably the anonymous financial instrument, which is at least anonymous with respect at least to the vendor, to complete the purchase of goods/services. Preferably, the anonymous financial instrument does not have the customer's actual name, and preferably the anonymous financial instrument also does not reveal any information for the customer's current financial instruments, other than what is on the anonymous financial instrument.

Although any means and/or methods for anonymous payment may be implemented within the context of the present invention, particularly well-suited methods and means for doing so are as follows: masked cards can be used to make purchases with a fictitious name (see abine.com); prepaid debit cards which can be purchased in places such as drugstores and supermarkets; using Bitcoin or other types of cryptocurrency or blockchain currency; and other services for anonymous payment such as Litecoin, Ripple, OpenCoin, MintChip, and Linden Dollars which let you pay anonymously for items and services. It is to be noted that the present invention also finds applicability in situations wherein the payment is not anonymous, but the customer does not wish to disclose the identity or name and/or the address of the customer and/or the recipient of the package to the vendor and to any situation in which the customer wishes to keep the intended delivery address and/or the actual name of the package recipient from the vendor. The present invention is also applicable to in-person cash transactions.

At step 314, the bank 20, or other trusted third party entity, processes the request for payment or anonymous payment for the goods purchased by the customer upon receiving the request for payment at step 312. The request for payment may be in the form of an electronic draft. Using generally accepted legal terms, a draft is a written order by a first party, called the drawer, instructing a second party, called the drawee, to pay money to a third party, called the payee. In terms of the present invention, the vendor may be thought of as the payee, the customer as the drawer and the bank may be thought of as the drawee. The bank 20 may then authorize, guarantee and/or release payment (on the electronic draft, for example) to the vendor for the goods/services (and/or the shipping charges) purchased by the customer.

At step 316 the bank 20 sends a payment confirmation to the vendor that the payment has been approved. Upon receiving notice from the bank 20 or other financial entity that payment from the customer's financial instrument, and preferably payment from the customer's anonymous financial instrument, has been approved, the vender then approves the purchase of goods/services from the customer and begins the process of delivering the goods/services purchased to the customer.

According to one embodiment of the present invention, at this time, the vendor then generates and affixes a shipping label, preferably an adhesive shipping label, onto the package, the shipping label bearing the tokenized customer name and the preferred intermediary address thereon. For example, the vendor may affix a label onto the package to be shipped, the label having the machine-readable indicia such as a barcode, PDF, DataGlyph or other code printed thereon. The vender then prepares to ship the package to the preferred intermediary address using a shipper such as, for example, the United States Postal Service or any private shipping or freight company, such as FedEx®, UPS® or DHL® for example.

In one example, the customer's actual name may be “John Smith” and his intended delivery address may be 10 South Main Street, Springfield, Ill. In this example, the third party entity would store this information in the secure database 210, and generate a tokenized customer name to represent the customer's name, such as “Todd211 Smith453,” and then provide the customer with the most economical or closest shipping intermediary address to the customer's address of 10 South Main Street, Springfield, Ill. which might be 102 North Blue Street, Chicago, Ill. The vender would then print a label which has the following information on it: “Todd211 Smith453, 102 North Blue Street, Chicago, Ill.,” and then affix the label on the package in which the item or service purchased by the customer resides, and then mails that package to the address on the label, which is not the customer's intended delivery address and which does not have the customer's actual name.

The shipper to which the package is sent via, may be selected by the customer or by the vender. As shown at step 318, the shipper then picks up the package at the vendor's location and delivers the package to the shipping intermediary at the preferred intermediary address which is located on the shipping label affixed to the package. Preferably, shipping intermediary then communicates the tokenized customer name from the shipping intermediary to the third party entity in order to indicate that the shipping intermediary has received the package. Upon receiving communication that the shipping intermediary has received the package, the third party entity can proceed to take steps in furtherance of delivering the package to the customer, such as shown in step 320, 401, and 500.

Moving to step 320, upon receiving the package, the shipping intermediary reads the unique tokenized customer name located on the adhesive shipping label on the package, matches the tokenized customer name with the actual name and intended delivery address associated with the customer's tokenized customer name, and prints out a second shipping label bearing the intended delivery address and actual name for the package associated which are associated with the tokenized customer name and affixes the second shipping label to the package. Preferably, the shipping intermediary first communicates the tokenized customer name from the shipping intermediary to the third party entity in order to indicate that the shipping intermediary has received the package. Then, upon receiving the tokenized customer name from the shipping intermediary, the third party entity provides the shipping intermediary with actual name and intended delivery address associated with the customer's tokenized customer name. In this manner, only the shipper, the shipping intermediary and/or third party entity have access to the actual name and intended delivery address. Yet neither the shipper, the shipping intermediary, and the third party entity would necessarily have access to or know what is being purchased by the customer.

Preferably, the shipping intermediary matches the tokenized customer name with the actual name and intended delivery address by determining what actual name and what intended delivery address stored in the secure database 210 are associated with the tokenized customer name found on the package.

Moving to step 322, the shipping intermediary may now ship the package to the address on the second shipping label, which is the intended delivery address for the package, in the usual manner. The shipped package may then be received at the intended delivery address, as shown at step 324, whereupon the method according to the present invention ends at step 326. In this manner, the package can be shipped from the vendor, to the preferred intermediary address, without divulging the intended delivery address for the package to the vendor.

In practice, the shipping intermediary may send the customer an estimate of when the shipper will pick up the package from the shipping intermediary and delivery it to the intended delivery address. When the customer provides the vender with at least one of the tokenized customer name, the preferred intermediary address, and the anonymous financial instrument, as shown in step 310, the customer preferably also sends the vender the shipping intermediary's name, the name of a contact person at the shipping intermediary, and other contact information such as telephone number(s), facsimile number(s) and email address of the shipping intermediary, for example. The vender may also send the shipper the shipping intermediary's telephone number or other contact information. This information may be sent to the shipper's database and thereafter replicated or otherwise downloaded into a portable digital device, such as a Palm Computing device, as manufactured/modified by Symbol Technologies, Inc., for example. Such a device may store a subset of the shipper's main database and assist the shipper with delivery of the package.

Moving to step 320, upon receiving the package, the shipping intermediary reads the unique tokenized customer name located on the adhesive shipping label on the package, matches the tokenized customer name with the actual name and intended delivery address associated with the customer's tokenized customer name, and prints out a second shipping label bearing the intended delivery address and actual name for the package associated which are associated with the tokenized customer name and affixes the second shipping label to the package. In this manner, only the shipper, the shipping intermediary and/or third party entity have access to the actual name and intended delivery address. Yet neither the shipper, the shipping intermediary, and the third party entity would necessarily have access to or know what is being purchased by the customer.

Preferably, the shipping intermediary matches the tokenized customer name with the actual name and intended delivery address by communicating with the secure database 210 and providing the tokenized customer name to the secure database in order to determine what actual name and what intended delivery address stored in the secure database 210 are associated with the tokenized customer name found on the package.

Moving to step 322, the shipping intermediary may now ship the package to the address on the second shipping label, which is the intended delivery address for the package, in the usual manner. The shipped package may then be received at the intended delivery address, as shown at step 324, whereupon the method according to the present invention ends at step 326.

With Reference to FIG. 4, in one embodiment, a local shipper may pick up the package from the vender at the vendor's location or from the intermediary at the intermediary address and delivers the package directly to the intended delivery address for the package. The local shipper is any shipping agent with the flexibility to pick-up and deliver packages on demand, and may include traditional shipping companies such as FedEX™ or UPS™, or may include non-traditional local delivery companies or ride-sharing services such as UBER™ and other such companies which manage or maintain a fleet of vehicles, such as private cars or taxi cabs which can be used for delivering both people and/or packages. The local shipper may also be a traditional courier service. Preferably, the local shipper is capable of directly shipping the item from a first address, such as the vender address or the intermediary address, to the intended delivery address using the local delivery's own systems and employees, thereby allowing the package to be shipped to the intended delivery address without ever having to print the actual name of the customer and the intended delivery address on the package at all. In this embodiment, a package can be delivered with only the information in the tokenized customer name. In one embodiment, the driver of the vehicle for the localized shipper has possession of the package from the time the package is picked up at the first address until the time the package is delivered at the intended delivery address, similar to a courier service.

The actual name of the customer and the intended delivery address can then be provided to the local shipper who then routes the package to the intended delivery address using this information, but without having to placing this information on the package. For example, the actual name of the customer and/or the intended delivery address can be displayed on a display of a computer, such as a laptop or smartphone, of the local shipper, along with the associated tokenized customer name. Preferably, only the intended delivery address is provided to the local shipper along with the associated tokenized customer name. Additionally, an application, such as a GPS guided navigation application can receive the intended delivery address, and not display the actual intended address, but guide the driver of the vehicle of the local shipper to the intended address and instruct the driver to deliver the package bearing the tokenized customer name associated with the intended delivery address at the intended delivery address. In this manner, the driver of the vehicle is never actually given the intended delivery address, but rather just directed to the intended delivery address. Furthermore, if the local shipper picks up the package from the intermediate address, the local shipper will not have to be given the vender's name, the customer's name, and even the intended deliver address—if directions or guidance are provided through a navigation application, in order to deliver the package to the intended delivery address, providing the customer with an additional level of privacy.

In accordance with this embodiment, at step 401, when a package needs to be shipped from the vendor's location or the intermediary address and delivered to the intended delivery address, a local shipper is notified by the third party entity and provided with a pickup address for picking up the package, and preferably is also provided with the tokenized customer name as well, and even possibly the intended shipping address associated with the tokenized customer name can also be provided at this time or at a later time. Preferably, the third party entity notifies the local shipper via a computer network using an application or app running on a local computer, such as a portable computer or smartphone. Preferably, in advance of notifying the local shipper, the shipping intermediary first communicates the tokenized customer name from the shipping intermediary to the third party entity in order to indicate that the shipping intermediary has received the package. Then, upon receiving the tokenized customer name from the shipping intermediary, the third party entity notifies the local shipper provides the local shipper with a pickup address for picking up the package.

At step 402, once provided with the pickup address, the local shipper then direct one of its vehicles to pickup address, which could either be the vender's location or the intermediary address. The package itself includes an adhesive shipping label with the tokenized customer name printed on it. In addition to the tokenized customer name, the adhesive shipping label may also include the intermediary address if it was shipped to the intermediary address, or it may not have any address on it at all, and only the tokenized customer name.

Unlike the previous embodiment described above, the adhesive shipping label does not need to have the intended delivery address on it in order to be delivered to the intended delivery address. In this embodiment, the intended delivery address may or may not be printed on the adhesive label when the package is being delivered to the intended delivery address. In one embodiment, the intended delivery address is not printed on the adhesive label when the package is picked up by the local shipper. In this embodiment, the tokenized customer name generated represents both the actual name of the customer and the intended delivery address, wherein the tokenized customer name does not include the actual name and any of the intended delivery address information for the package. In this manner, using this tokenized customer name can allow for the anonymous shipment of the package to the intended delivery address.

At step 404, upon arriving at the pickup address, the local shipper, preferably using a scanner or an application and a portable computer or smartphone, scans the tokenized customer name printed on the adhesive shipping label on the package and confirms that it matches the tokenized customer name provided previously to the local shipper. If the intended delivery address has not yet been provided to the local shipper, the local shipper is then provided with the intended delivery address. Preferably, the intended delivery address is provided to the local shipper via a display on a smartphone or computer, and preferably using an application or app running on that smartphone or computer. In this manner, the package can be delivered to the intended delivery address without having the intended delivery address printed on the package at all. At step 408, upon receiving both the package and the intended delivery address, the local shipper then delivers the package to the intended delivery address.

In one embodiment, the customer has the flexibility of changing the intended delivery address at any time before the package is shipped to the intended delivery address from the intermediary address or the vender's address by providing as modified intended delivery address to the third party intermediary before either the shipping label bearing the intended delivery address is printed and affixed to the package, before the package is shipped to the intermediary address, or before the package is delivered to the intermediary address. If the package is being shipped by a local shipper, the third party intermediary can provide the local shipper with a modified intended delivery address anytime before the package is delivered to the intended delivery address, and the local shipper will be notified of this change and reroute his vehicle accordingly.

In one embodiment, the local shipper can also be provided with a list of packages to be delivered and their associated tokenized customer names and intended delivery addresses, along with a route and a time for delivery of each package. Additionally, if using a localized shipper or any shipper, constant package tracking information showing the current location of the package can be transmitted to the third party intermediary and in turn the customer to provide near real-time or real-time tracking of the package.

With reference to FIG. 5, in one embodiment, after the package is delivered to the shipping intermediary at the intermediary address by the shipper at step 318, the shipping intermediary stores the package for receipt by the customer at step 500. Alternatively, if the shipping intermediary and the vender are one and the same, then step 318 can be skipped, and the method can go directly to steps 500 and 501, whereby the shipper need not be involved at all, the package remains at the vender. Preferably, in advance of storing the package, the shipping intermediary scans the package, preferably with a client device, for the tokenized customer name and/or some other identifying information on the package in order to determine if the storage of the package has been authorized by the customer and/or the third party entity. Preferably, the tokenized customer name and/or some other identifying information on the package is then forwarded to the third party entity, and specifically to the secure database 210. If the tokenized customer name and/or some other identifying information on the package is not able to be found in the database, or if it is found but determined by the third party entity that no package delivery was authorized, then the shipping intermediary is requested to return the package to the sender and not store the package. If the tokenized customer name and/or some other identifying information on the package is able to be found in the secure database 210, and it is determined that the package delivery was authorized, then the package is stored for receipt by the customer by the shipping intermediary, at step 500.

In one embodiment, the centralized server queries the secure database 210 for the received tokenized customer name in order to determine if the package delivery was authorized. Preferably, if the tokenized customer name is found in the secure database 210 and it has been designated as authorized, meaning it has been designed as approved for use, the centralized server communicates this information to the client device of the shipping intermediary, and the shipping intermediary stores the package. If, however, the tokenized customer name is not found in the secure database 210 or it has been found but it has not been designated as authorized, the centralized server communicates this information to the client device of the shipping intermediary, and the shipping intermediary is instructed not store the package but rather to return the package to its sender, or the vender.

Preferably, upon receipt of the package by the shipping intermediary, and preferably upon determining that the package delivery was authorized, the shipping intermediary, the centralized server, and/or the third party entity alerts the customer, preferably via electronic communication such as e-mail, SMS/text message, or an alert on the customer's smartphone or computer, that the customer's package has arrived and is being stored for receipt by the shipping intermediary, and preferably, the customer is also asked to retrieve the package, preferably within a set amount of time or a penalty or fine will be assessed to the customer. Preferably, the communications device of the centralized server transmits information to a client device of the customer to alert the customer that the shipping intermediary has received the package upon receiving confirmation from the shipping intermediary that the package has been received.

Moving to step 501, preferably after the customer is alerted to the receipt of the package by the shipping intermediary, the customer arrives at the shipping intermediary, preferably at the shipping intermediary's address, and the customer presents a secondary token to the shipping intermediary as confirmation of ownership of the package in order to receive the package from the shipping intermediary. Alternatively, if the shipping intermediary and the vender are one and the same, then step 318 can be skipped, and the method can go directly to steps 500 and 501, whereby the shipper need not be involved at all, the package remains at the vender, and the customer presents a secondary token to the vender, which is now also the shipping intermediary, and the intermediary matches the secondary token with the tokenized customer name in order to provide the package directly to the customer. In one embodiment, the shipping intermediary communicates the secondary token, via a client device, to the third party entity and more specifically to the centralized server, which then confirms whether or not the secondary token is valid, determines what tokenized customer name is associated with the secondary token and communicates the tokenized customer name associated with the secondary token to the shipping intermediary, and specifically the client device.

The secondary token is can be any one of a number of items, such as a bar code, a symbol, an illustration, or any alphanumeric combination of letters, numbers, and/or symbols which are generated by the third party entity and associated with an account maintained by the third party entity for the customer, and specifically, associated with the tokenized customer name. In one embodiment, the secondary token is simply the tokenized customer name. Preferably, the secondary token is unique to each customer, and more preferably unique to each package. Preferably, the secondary token is equivalent to a confirmation code, that is an alphanumeric code or symbol that can be used to confirm that the intended recipient of the package is the customer. In one embodiment, the secondary token is the same as the tokenized customer name. In one embodiment, a new secondary token, which is associated with the tokenized customer name, is generated for every purchase made by the customer and/or every package shipped to each customer. In this manner, a customer can go to the shipping intermediary at the intermediary address, present only the secondary token, and receive the package from the intermediary or vendor with nothing more than just presenting the secondary token. In this manner, the customer can purchase a product from a vender, preferably via the vender's ecommerce website located on the Internet, and receive the product without having to provide the vender or intermediary with the customer's name and/or address.

Moving to step 502, upon the customer, or the agent of the customer presenting the secondary token to the shipping intermediary, upon the shipping intermediary receiving the secondary token, and upon the shipping intermediary determining the tokenized customer name is associated with the secondary token, the shipping intermediary retrieves the package for the customer. Upon retrieving the package, the shipping intermediary then presents the package, preferably with the tokenized customer name, to the customer or customer's agent at step 503. As used herein, the term customer will refer to either the customer or the customer's agent. Preferably, upon presenting the package to the customer, the customer is requested to confirm receipt of the package before being allowed to take the package. The customer may be requested to confirm receipt of the package in one of a number of ways. In one embodiment, an electronic message is either sent from or received by the customer confirming that the customer has received the package. Preferably the electronic message is sent from an account associated with the customer, such as the customer's email account or telephone number. In this way, confirmation from the customer of receipt allows the shipping intermediary and the third party entity to have confirmation that the customer has received the package.

In one embodiment, the secondary token is the same as the tokenized customer name, in this way by simply providing the secondary token to the shipping intermediary, the shipping intermediary is able to scan the current packages and determine which package if any is the customer's package. In this embodiment, the tokenized customer name essentially identifies that the customer is the owner of the package which bears the same tokenized customer name.

In one embodiment, the shipping intermediary uses a person, preferably a person with a personal computer, to receive the secondary token, confirm the secondary token is valid, and retrieve the package for the customer. In one embodiment, the secondary token is transmitted to the secure database 210, wherein the computer 110 determines which tokenized customer name is associated with the secondary token. Then the computer 110 communicates this information, that is, which tokenized customer name is associated with the secondary token to the shipping intermediary, and the person working at the shipping intermediary, preferably via the personal computer. Upon determining which tokenized customer name is associated with the secondary token, the shipping intermediary then locates the package that is associated with the tokenized customer name and provides that package to the customer. Preferably, the package has a label, such as a shipping label, with the tokenized customer name on it. However, if the shipping intermediary is the vender, and no shipping label is on the package, then the package may include some other identifying features or information, which is on or about the package, that identifies the package and is associated with the tokenized customer name. Using this identifying features or information, the shipping intermediary is able to locate the package associated with the tokenized customer name, and provide that package to the customer upon receipt of the secondary token.

With reference to FIG. 6, in one embodiment, the shipping intermediary uses or includes an automated system, preferably a smart electronic automated locker 600 which is connected to a network 602 like the Internet, to receive and store the package 604, to receive the secondary token from the customer, to confirm the secondary token is valid, and to retrieve and provide the package 604 to the customer. The smart electronic automated locker 600 is a unit which includes a computer 606 having an input 608, such as a keypad 610, an optical scanner or camera 611, and/or barcode reader 612, a screen 614, and preferably is connected with the network 602 via a communication device, such as the smart electronic lockers provided by Parcel Pending of Irvine, Calif. in the United States. Upon purchase, the package 604 is delivered to the automated locker 600 either personally by the vender or via an agent of the venders, or via a shipper which picks up the package 604 from the vender and delivers the package 604 to an intermediary, as discussed in step 318. Upon receipt of the package 604 at the automated locker, a person delivering the package 604 would then enter the tokenized customer name 616 and/or some other identifying information on the package 604, such as a tracking number, which could uniquely identify the package and the customer. Upon receiving either the tokenized customer name 616 and/or some other identifying information on the package 604, the automated locker 600 would then either assign or be given instructions from the centralized server of the third party entity to assign, a compartment 618 of a specific size or location within the automated locker 600 for the package 604 to reside. Upon receiving this information, the automated locker would then open a door 620 of that assigned compartment 618, and the person delivering the package 604 would then insert the package 604 in the assigned compartment 618 and close the door 620 of the compartment 618 to secure the package 604 in the compartment 618.

Once secured in the compartment 618, the package 604 would await for the customer, or an agent of the customer's, to arrive at the automated locker 600 and retrieve the package 604. In order to retrieve the package 604, the customer, or an agent of the customer's, would provide the automated locker 600 with the secondary token, by either scanning a code or symbol or other graphic using the scanner 611 or barcode reader 612 or by entering an alphanumeric code via the keypad 610 of the automated locker 600. In one embodiment, the automated locker 600, via the network 602, would communicate with the secure database 210 and determine which compartment 618 within the automated locker 600 is associated with the secondary token, and more specifically is associated with the tokenized customer name 616 that is associated with the secondary token.

Upon determining which compartment 618 is associated with the secondary token, the automated locker 600 would then open the door 620 to that compartment 618. In one embodiment, the automated locker 600 would itself determine which package 604 is associated with the secondary token by determining which tokenized customer name 616 is associated with second token, from a list of tokenized customer names that are each associated with a compartment 618 within the automated locker 600, and then based upon this association, open the compartment 618 that is associated with the tokenized customer name 616 that is associated to the secondary token.

In one embodiment, upon retrieval of the package by the customer, or an agent of the customer, from the shipping intermediary, the customer provides payment to the shipping intermediary for the service of receiving, maintaining, and ultimately retrieving the customer's package. Payment can be provided in any form, including cash or Bitcoin, to afford the customer a level of privacy and not have to disclose the customer's personal financial information to the shipping intermediary. In one embodiment, payment can be provided directly to the automated locker 600, and the locker may provide a receipt for such payment. In this manner, by presenting a secondary token to the intermediary and the intermediary presenting this package to the customer, as discussed in steps 501 and 502, a customer could order goods/services from a vender, have those goods/services shipped in a package to a shipping intermediary for later retrieval by the customer, without the customer having to provide his actual name and address or other personal information which may identify the customer.

The methods and systems for anonymous shipment according to the present invention may also be utilized for shipping packages to addresses other than the address of the customer. For example, the package may be “in care of” the customer, but addressed to another person at another address, the recipient of the package. In that case, the customer may store the “Care of” address within the secure database 210 and specify that the “Care of” address is to be substituted for the delivery address. Alternatively, the package may be a gift, or may have been bought on behalf of a person other than the customer. In this case, the customer may have caused a “Send to” address to be stored within the secure database 210, and the “Send to” address may be selected by the customer upon purchasing the products/services from the vender. In the case wherein a package is undeliverable for any reason, the shipper may return the package to the shipping intermediary or to some location specified by the shipping intermediary. Thereafter, the shipping intermediary may generate a message (such as an email, for example) informing the customer that his or her package is undeliverable. A charge may be levied against the customer's account to cover the costs associated with shipping and storing an undeliverable package.

The present invention, therefore, provides for an anonymous shipment system and method by which the customer's personal, and preferably, financial information is safeguarded by entities having a fiduciary and/or contractual agreement to limit the dissemination of such information. For example, the shipper may be under a contractual obligation with the shipping intermediary not to make any disclosure of the personal and/or financial information gained through participation in the method or use of the system disclosed herein. Preferably, the shipping intermediary may only sell aggregate customer information to third parties, unless the customer has previously given the shipping intermediary his or her (full or limited) consent to the dissemination of his or her confidential information. The vendor, therefore, may purchase aggregate information (i.e., information that does not identify any one customer) for use in sales and/or marketing efforts, for example. The aggregate customer information may be filtered and sorted by the shipping intermediary to provide the vendors only with that information that they have requested, and only in the form in which they have requested the information. The vendor's sales and marketing informational needs are satisfied, therefore, without subjecting the customer to unwanted solicitations and intrusions into their privacy.

Should, however, the vendor wish to contact the customer to notify the customer of a product recall or to send the customer advertisement and special promotions, the vendor may send same electronically to the shipping intermediary, including therein the tokenized customer name sent to the vender. The shipping intermediary may then forward the electronic recall, advertisement or promotion to the customer's physical or electronic address (e.g., email address), unless the customer bank account holder has previously indicated his or her preference not to receive any such messages or messages from this vendor, excepting, for example, product safety and recall information. Therefore, the vendor's link to the customer is not necessarily severed, but is managed and under the control of the customer, which is the party bearing the risk of loss in the case of uncontrolled dissemination of personal information. Implementation of the present method and system eventually recaptures the customer's confidentiality, as the vendors' databases will no longer be updated as the customer's personal and financial information changes. Instead, only the shipping intermediary and the shipper, both under a duty to preserve the confidentiality of the customer's information, will have access thereto.

The shipping intermediary, according to the present invention, may guarantee that the shipper's charges will be paid. Indeed, the shipper may be paid directly from the account holder's account. In this manner, the vendor preferably only charges for the cost of the item and for shipping that item to the shipping intermediary, which often times is bore by the vender.

In the case wherein the goods purchased by the customer form the vendor are in electronic form, such as software, music or data, the shipping intermediary may provide the customer, who later provides the vender with, a tokenized customer name and preferred intermediary address which may also include or be in the form of electronic forwarding address to which to forward the customer's purchase. The vendor may then transmit the software, music or data to the specified electronic forwarding address, together with the tokenized customer name. The shipping intermediary may then match the tokenized customer name with the customer's account(s) and cause the software, music, or other digital data purchased by the customer to the customer's own electronic address, to the customer's “Care of” electronic address or to the customer's “Send to” electronic address, as specified by the customer upon purchasing the item and arranging for its payment, whether anonymous or otherwise. The customer may modify his or her payment information, physical address(es), electronic address(es), “Care of” address(es), “Send to” address(es) or any other delivery address(es) at any time by logging onto a secure Web site maintained and controlled by the shipping intermediary, becoming authenticated by the shipping intermediary by means of an ID/Password pair (for example), and entering/modifying the desired information by clicking a “Shipping Options” selection, for example.

In one embodiment, the third party entity owns and develops an online shopping platform through which the venders can sell their goods and services to the customers, and through which goods and services can be shipped to customers anonymously. The customers and the venders are both registered with and create an account with the online shopping platform of the third party entity. Upon creating an account with the online shopping platform, the venders are then able to sell products, either on their own website, or via a website provided to them by the online shopping platform. The customer and/or vender may open an account with the third party entity simply by just creating a username and password with the third party entity, wherein the username and password are stored in the secure database.

In this embodiment, upon opening an account with the third party entity, the third party entity then generates the tokenized customer name along with determining the preferred intermediary address associated with a shipping intermediary, wherein the tokenized customer name and the preferred intermediary address do not include the customer's actual name and the customer's intended delivery address. Then, the third party entity directly sends the tokenized customer name and the preferred intermediary address from the secure database in the computer operated by the third party entity directly to the vender, instead of the customer having to supply this information to the vender when the customer is looking to purchase goods and/or services from the vender, and both the vender and the customer are logged into and operating on the online shopping platform. In this manner, if the vender is registered with and connected with the online shopping platform, and the customer is also registered with and connected with the online shopping platform, the customer does not have to provide the vender the vender the tokenized customer name in place of the customer's actual name and the preferred intermediary address in place of the customer's intended delivery address, but rather the third party entity can provide this information directly to the vender via the online shopping platform.

Additionally, in one embodiment, the third party entity also provides the customer's financial instrument, and possibly an anonymous financial instrument connected with the customer's account, to the vender directly, or provide an option for the customer to select a financial instrument, and that is then provided to the vender from the third party entity. In one embodiment, the third party entity acts as an intermediary for the financial instrument, and provides payment to the vender via the customer's financial instrument without providing the customer's financial instrument to the vender. In this manner, the customer is provided the convenience of not having to provide the vender with the customer's actual name and the preferred intermediary address, but yet still be able to shop with the vender anonymously and have goods and/or services delivered anonymously as well.

In the foregoing specification, specific embodiments have been described. However, one of ordinary skill in the art appreciates that various modifications and changes can be made without departing from either the spirit of the invention or the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for enabling anonymous shipment of a package purchased by a customer from a vendor for delivery to the customer at an address unknown to the vendor, whereby the customer has an actual name and an intended delivery address, the method comprising:
generating a tokenized customer name along with a preferred intermediary address associated with a shipping intermediary, wherein the tokenized customer name and the preferred intermediary address do not include the customer's actual name and the customer's intended delivery address;
sending the tokenized customer name and the preferred intermediary address from a secure database in a computer operated by a third party entity directly to the vender;
delivering the package to the preferred intermediary address associated with the shipping intermediary, wherein the package includes the tokenized customer name.

2. The method of claim 1, further comprising communicating the tokenized customer name from the shipping intermediary to the third party entity in order to indicate that the shipping intermediary has received the package.

3. The method of claim 1, further comprising:
providing a local shipper with a pickup address for picking up the package, wherein the pickup address is the preferred intermediary address.

4. The method of claim 1, further comprising:
providing the shipping intermediary with actual name and intended delivery address associated with the customer's tokenized customer name; and
shipping the package from the shipping intermediary with actual name and intended delivery address associated with the customer's tokenized customer name.

5. The method of claim 1, wherein the shipping intermediary is the vender.

6. The method of claim 1, further comprising:
storing the package for receipt by the customer at the shipping intermediary if it is determined by the third party entity upon receipt of the tokenized customer name that the package delivery was authorized.

7. The method of claim 5 further comprising:
alerting the customer that the shipping intermediary has received the package.

8. The method of claim 5 further comprising:
receiving a secondary token from the customer or an agent of the customer;
determining the tokenized customer name associated with the secondary token; and
retrieving the package which includes the tokenized customer name associated with the secondary token; and
providing the package which includes the tokenized customer name associated with the secondary token to the customer or the agent of the customer.

9. The method of claim 7, wherein the secondary token is the tokenized customer name.

10. The method of claim 5, wherein the shipping intermediary uses a smart electronic automated locker to store the package for receipt by the customer.

11. The method of claim 1, wherein the shipping intermediary includes multiple shipping intermediaries, and wherein each shipping intermediary has its own unique shipping intermediary address, and wherein the preferred intermediary address is determined by finding the shipping intermediary addresses which allows for shipping the package in a least amount of time.

12. The method of claim 1, wherein the shipping intermediary includes multiple shipping intermediaries, and wherein each shipping intermediary has its own unique shipping intermediary address, and wherein the preferred intermediary address is determined by finding the shipping intermediary addresses which allows for shipping the package at a lowest possible cost.

13. The method of claim 1, wherein the customer pays for the package via an anonymous payment requested through a bank.

14. The method of claim 1, wherein the third party entity generates an anonymous financial instrument for the customer and provides the anonymous financial instrument to the customer for payment to the vender.

15. A system for enabling anonymous shipment of a package purchased by a customer from a vendor for delivery to the customer at an address unknown to the vendor, whereby the customer has an actual name and an intended delivery address, the system comprising:
a centralized server coupled to a client device through a network, the centralized server including,
a tokenized customer name generator for generating a tokenized customer name which is unique and does not include the customer's actual name,
a preferred intermediary address engine for determining a preferred intermediary address associated with a shipping intermediary, wherein the preferred intermediary address does not include the customer's intended delivery address;
a secure database for storing the tokenized name generator and the preferred intermediary address in an account associated with the customer;
a communications device for sending the tokenized customer name and the preferred intermediary address from the secure database to a client device of the vender, wherein a third party entity provides to the vender the tokenized customer name in place of the customer's actual name and the preferred intermediary address in place of the customer's intended delivery address, and wherein the package is delivered to the shipping intermediary using the tokenized customer name.

16. The system of claim 14, wherein the communications device receives the tokenized customer name from a client device of the shipping intermediary in order to determine if storage of the package is authorized, and wherein the centralized server queries the secure database for the received tokenized customer name in order to determine if the package delivery was authorized, wherein if the tokenized customer name is found in the secure database and has been designated as authorized, the centralized server communicates this information to the client device of the shipping intermediary, and the shipping intermediary stores the package.

17. The system of claim 15, wherein the communications device transmits information to a client device of the customer to alert the customer that the shipping intermediary has received the package upon receiving confirmation from the shipping intermediary that the package has been received.

18. The system of claim 15, wherein a secondary token is transmitted to the communications device from the client device of the shipping intermediary, and wherein the centralized server queries the secure database to determine the tokenized customer name associated with the secondary token, and wherein the communications device transmits the tokenized customer name associated with the secondary token to the client device of the shipping intermediary to allow the shipping intermediary to retrieve the package which includes the tokenized customer name associated with the secondary token.

19. The system of claim 15, wherein the customer or an agent of the customer provides the shipping intermediary with the secondary token as confirmation of ownership of the package in order to receive the package from the shipping intermediary.

20. The system of claim 15, wherein the client device of the shipping intermediary is a smart electronic automated locker used to store the package for receipt by the customer.

21. The system of claim 15, wherein the shipping intermediary includes multiple shipping intermediaries, and wherein each shipping intermediary has its own unique shipping intermediary address, and wherein the preferred intermediary address is determined by finding the shipping intermediary addresses which allows for shipping the package in a least amount of time.

22. The system of claim 15, wherein the shipping intermediary includes multiple shipping intermediaries, and wherein each shipping intermediary has its own unique shipping intermediary address, and wherein the preferred intermediary address is determined by finding the shipping intermediary addresses which allows for shipping the package at a lowest possible cost.
